(19) United States
(12) Patent Application Publication
(10) Pub. No.: US 2004/0143083 A1
(43) Pub. Date: Jul. 22, 2004

(54) Novel coating systems

(76) Inventors: Christoph Gurtler, Koln (DE); Hanno Brummer, League City, TX (US); Reinhard Halpaap, Odenthal (DE); Jorg Tillack, Bergisch Gladbach (DE); Birgit Willwerth-Schwarten, Leichlingen (DE)

Correspondence Address: BAYER POLYMERS LLC, 100 BAYER ROAD, PITTSBURGH, PA, 15205, US

(21) Appl. No.: 10/751,220

(22) Filed: Jan. 2, 2004

(30) Foreign Application Priority Data
Jan. 7, 2003 (DE) 10300155.7

(51) Int. Cl. C08G 18/00

(52) U.S. Cl. 528/44

(57) ABSTRACT

The present invention concerns novel reactive one-component coating systems, a process for their production and their use in one-component polyurethane systems.

### CROSS REFERENCE TO RELATED PATENT APPLICATION

The present patent application claims the right of priority, under 35 U.S.C. §119 (a)-(d) of German Patent Application No.103 00 155.7, filed Jan. 7, 2002.

### FIELD OF THE INVENTION

The present invention concerns coating systems based on polyurethanes. In particular the present invention concerns novel one-component polyurethane paint systems, which are based on the crosslinking of blocked alcohols with polyisocyanates in the presence of a catalyst, and their use in one-component polyurethane systems.

### BACKGROUND OF THE INVENTION

The procedure of blocking polyisocyanates for the short-term protection of isocyanate groups has long been known and is described for example in Houben Weyl, Methoden der organischen Chemie XIV/2, p. 61-70. Curable compositions containing blocked polyisocyanates are used for example in polyurethane paints.

One-component (1C) polyurethane systems are widely used in the area of industrial stoving enamels, such as standard automotive paints and coil coating, and are characterised by very good film properties, such as chemical resistance, scratch resistance and weathering resistance. In conventional 1C PUR systems the paint films are cured by heat activation (stoving process) of the blocked polyisocyanates with polyols; optionally in the presence of a suitable catalyst. An overview of blocking agents that are suitable in principle can be found e.g. in Wicks et al. in Progress in Organic Coatings 1975, 3, p. 73-79, 1981, 9, p. 3-28 and 1999, 36, p. 148-172.

For the area of application of automotive painting, the blocked polyisocyanates must be capable of crosslinking at stoving temperatures of a maximum of 140° C. and display little or preferably no heat yellowing during the stoving process. The stoving temperature is controlled primarily via the reactivity of the blocked polyisocyanate. Lower stoving temperatures are generally desirable and are essential for the coating of materials that are not thermally stable, such as e.g. plastic parts.

Conventional 1C systems typically have the disadvantage that a certain proportion of the blocking agent remains in the paint film that is formed and exerts a disadvantageous influence on its properties. This is attributable not least to the properties of the blocking agents (conventionally heterocyclic compounds containing amines or nitrogen) that are typically used for the blocking of isocyanates. Properties such as scratch resistance and acid resistance of one-component paint finishes, because of the residual blocking agent, are not comparable with those of so-called two-component (2C) polyurethane paint systems (e.g. T. Engbert, E. König, E. Jürgens, Farbe&Lack, Curt R. Vincentz Verlag, Hanover 10/1995).

For particularly low stoving temperatures in the range from 90 to 120° C., isocyanates blocked with diethyl malonate have predominantly been used recently (e.g. EP-A 0 947 531). In contrast to blocking reactions with e.g. N-heterocyclic compounds such as 3,5-dimethyl pyrazole or other blocking agents such as caprolactam or butanone oxime, in this case not all of the blocking agent is released; instead this blocking agent leads to an interesterification at the diethyl malonate-blocked isocyanate. Ethanol is released during this interesterification. This process can be performed at relatively low stoving temperatures, as the second, adjacent ester function means that this is an activated ester. The disadvantage of this process is that such systems are extremely susceptible to the action of acids, since the unstable ester bond can quickly be split. The possible applications of these products are therefore restricted.

The object of the present invention was therefore to provide novel reactive 1C PUR systems that permit painting of e.g. materials that are not thermally stable at relatively low temperatures of approx. 90° C. and are therefore suitable for the painting of e.g. plastic parts. Furthermore, these reactive 1C PUR systems should be stable at ambient temperature for a period that allows for practical processing and be suitable for the production of high-quality one-component stoving enamels.

### SUMMARY OF THE INVENTION

The present invention is directed to a coating system that includes organic polyisocyanates with at least two isocyanate groups, at least difunctional alcohols that are not present in their O—H acid form, and a catalyst to accelerate the alcohol-isocyanate reaction.

The present invention is also directed to a process for producing polyurethane paint films including reacting blocked alcohols with polyisocyanates in the presence of one or more catalysts.

The present invention is further directed to surface coatings obtained from the coating system described above as well as substrates coated with the present surface coatings.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has now been found that the reaction of blocked alcohols with diisocyanates or polyisocyanates in the presence of one or more suitable catalysts can be used to achieve the stated object. Highly chemically resistant coatings having a very low yellowing tendency are produced even at very low stoving temperatures of approx. 90° C. over a stoving period of 30 minutes. The presence of atmospheric moisture is not critical for this curing process. The systems according to the invention are also suitable for the production of adhesives and textile and leather coatings. Such systems are modified according to the intended usage by methods of the prior art known to the person skilled in the art.

The blocking of hydrokyl groups in organic chemistry is a known technique. An overview is provided in Houben-Weyl, “Methoden der Organischen Chemie”, Volume E 20/2 “Makromolekulare Stoffe”, Georg Thieme Verlag, 1987, p. 1650. The reaction of hydroxyl groups with α,β-unsaturated ethers to acetal structures is described. Methyl vinyl ether and dihydropyran are explicitly cited as blocking agents. The release of hydroxyl function takes place in the presence of moisture and another nucleophile, optionally using a Brønsted acid.

DE-A 3 310 532 describes the addition of hydroxyl groups to N-vinyl urethanes and N-vinyl amides to form the corresponding ethers. This reaction is reversible. The vinyl monomers are regenerated in the presence of isocyanates at 110° C. A disadvantage here is that the N-vinyl urethane or amide component remains in the paint film and presumably has a decisive influence on its properties and on yellowing at elevated stoving temperatures.

A further disadvantage of this type of blocking of hydroxyl groups is the sharp rise in viscosity of the blocked alcohol component that is used. This makes a use in so-called high-solid applications, i.e. in paint formulations containing only very small amounts of a solvent, virtually impossible.

The use of acetal-containing polyol components in painting or coating applications has been mentioned many times. It should be emphasised that the purpose of using acetal-containing polyol components is primarily to reduce the viscosity of the paint mixture, however, not to bring about crosslinking reactions (cf. EP-A 0 908 479).

DE-A 2 424 522 describes coating systems based on blocked polyols, which are preferably reacted with aromatic polyisocyanates. Methyl isoprenyl ether is used here as the blocking agent. Curing takes place in the presence of atmospheric moisture. The use of catalysts for coating applications is also described, although 7.4 wt. % of catalyst has to be added. Tin(II) octoate, lead(II) octoate, dibutyl tin dilaureate, dibutyl tin diacetate and mixtures thereof are cited as catalysts. The use of such a large amount of heavy metal-containing catalysts is not feasible for a technical application as a coating. It must also be taken into consideration that tin(II) octoate and lead(II) octoate are unsuitable for thermally crosslinking applications because of the formation of (white) metal oxides, which can lead to film haze.

Common to all of the systems that have been described so far is that the reaction of the blocked alcohols with the isocyanate groups takes place with the use of another nucleophile such as e.g. water (an additional catalyst is optionally added to accelerate the subsequent reaction of the alcohol thus formed with the isocyanate) or in the presence of a Brønsted acid, again preferably in the presence of a nucleophile. This is not desirable, since the absorption of atmospheric moisture during the stoving reaction leads to formation of ureas, which make full curing of the paint film more difficult due to a reaction at the paint surface and lead to paint properties differing from those expected of the desired polyurethane films. The presence of water for the formation of a polyurethane paint is therefore undesirable. At the same time it is undesirable to leave acid residues in the paint film. It should be assumed that these acid residues have a negative influence on the long-term stability of the paint films.

It has now been found that in the presence of suitable catalysts the reaction of blocked alcohols with (poly)isocyanates to polyurethane paint films takes place in full. The presence of atmospheric moisture is not necessary in this process. This process has not been described before and at stoving temperatures of 90-100° C. it leads to chemically resistant, lightfast paint films. It has been demonstrated in NMR examinations that the blocking agent is released during crosslinking and a polyurethane paint film is produced.

In the process according to the invention the reaction of acetal-blocked alcohols with isocyanate groups can be brought about in the presence of selected Lewis acids at low temperatures from 80° C. without the presence of an additional nucleophile such as water, an alcohol or an amine or another nucleophile. The addition of a Brønsted acid is not necessary in this process.

The use of a catalyst, which brings about crosslinking under the desired conditions (see above), forms a part of the process according to the invention.

The invention thus provides one-component coating systems including or consisting of organic polyisocyanates with at least two isocyanate groups and at least difunctional alcohols that are not present in their O—H acid form and additionally a catalyst for low stoving temperatures to accelerate the reaction.

In the process according to the invention -any organic compounds can be used that display at least two alcoholic hydroxyl groups but are otherwise inert under the conditions of the reaction according to the invention. Dihydric to hexahydric, in particular dihydric to trihydric, aliphatic alcohols displaying ether or ester bridges and in the molecular weight range from 62 to 5000, preferably 62 to 3000, are preferably used as such compounds. This means that the compounds displaying alcoholic hydroxyl groups that are preferably used are the polyhydroxyl compounds known from polyurethane chemistry. Aliphatic alcohols containing more than six hydroxy groups, for example, or optionally polyhydric cycloaliphatic or araliphatic alcohols displaying inert substituents, can also be used in the process according to the invention in addition to these preferred polyhydroxyl compounds, however. The compounds displaying hydroxyl groups for use in the process according to the invention preferably have exclusively primary and/or secondary hydroxyl groups.

Typical examples of compounds with alcoholic hydroxyl groups that are suitable according to the invention are primary and secondary dihydroxy compounds in the molecular weight range 62 to 300, such as glycol, 2,2′-dihydroxydiethyl ether, 1,2-bis-(2-hydroxyethoxy) ethane, tetraethylene glycol, bis-(2-hydroxyethyl) sulfide, 1,2-propanediol, dipropylene glycol, tripropylene glycol, 3-chloro-1,2-propanediol, 1,3-propanediol, 1,2-butanediol, 1,3-butanediol, 1,4-butanediol, 2,3-butanediol, 1,5-pentanediol, 2,2-dimethyl-1,3-propanediol, 1,6-hexanediol, 2,5-hexanediol, 2,2-diethyl-1,3-propanediol, 1,8-octanediol, 1,10-decanediol, 1,12-dodecanediol, 1,12-octadecanediol, 2-butene-1,4-diol, 2-butyne-1,4-diol, 1,2-cyclohexanediol, 1,4-cyclohexanediol. Also suitable are primary and/or secondary trihydric or polyhydric alcohols in the molecular weight range 92 to 350, such as glycerol, 1,2,6-hexanetriol, 2-ethyl-2-hydroxymethyl-1,3-propanediol, 2,2-bis-hydroxymethyl-1,3-propanediol. Also suitable are polyester or polyether polyols in the molecular weight range 300 to 5000, preferably 1000 to 3000, which generally display 2 to 6, preferably 2 to 3 alcoholic hydroxyl groups, and polyacrylate polyols having a hydroxyl value between 20 and 300, preferably 35 and 200, and a molecular weight between 1000 and 20,000. In addition, alcohols that can be obtained by reactions of polyfunctional isocyanates or polyisocyanates with at least dialcohols can also be used (e.g. THEIC=tris-hydroxyethyl isocyanurate).

Reaction partners for these compounds having alcoholic hydroxyl groups are any organic compounds that display at least one structural unit having the formula (I) and are otherwise inert under the conditions of the process according to the invention.

Typical representatives of such compounds are those having the formula (I)

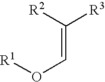

wherein

R¹ can be any aliphatic, araliphatic radical

R² can be any aliphatic, araliphatic radical

R³ can be any aliphatic araliphatic radical.

The radicals R¹ and R² can be linked together by hydroxymethylene groups.

Typical representatives of these structures are aliphatic vinyl ethers such as e.g. dihydropyran, methoxypropene, butyl vinyl ether, isobutyl vinyl ether, ethyl vinyl ether, these being intended by way of example only. Various methods can be considered for blocking the alcohols. An overview of them is provided by T. W. Greene in “Protective Groups in Organic Synthesis”, 2^{nd} edition; John Wiley and Sons, New York 1991, page 31.

The diisocyanate or polyisocyanate in the reactive 1C PUR system can be any organic polyisocyanate that in classical polyurethane systems is suitable for crosslinking compounds with active hydrogen, i.e. aliphatic including cycloaliphatic, aromatic and heterocyclic polyisocyanates having at least two isocyanate groups and mixtures thereof. Typical examples of polyisocyanates are aliphatic isocyanates such as diisocyanates or triisocyanates, e.g. butane diisocyanate (BDI), pentane diisocyanate, hexane diisocyanate (HDI), 4-isocyanatomethyl-1,8-octane diisocyanate (triisocyanatononane, TIN) or cyclic systems, such as 4,4′-methylene-bis(cyclohexyl isocyanate) (Desmodur W, Bayer A G, Leverkusen), 3,5,5-trimethyl-1-isocyanato-3-isocyanatomethyl cyclohexane (IPDI) and ω,ω′-diisocyanato-1,3-dimethyl cyclohexane (H₆XDI). Examples of aromatic polyisocyanates are 1,5-naphthalene diisocyanate, diisocyanatodiphenyl methane (MDI) or crude MDI, diisocyanatomethyl benzene (TDI), in particular the 2,4 and the 2,6 isomers and technical mixtures of the two isomers, and 1,3-bis(isocyanatomethyl) benzene (XDI). Likewise very suitable are also polyisocyanates, which can be obtained by reacting the diisocyanates or triisocyanates with themselves via isocyanate groups, such as uretdiones or carbodiimide compounds or such as isocyanurates or iminooxadiazine diones, which are formed by reaction of three isocyanate groups. The polyisocyanates can also contain monomeric diisocyanates and/or triisocyanates and/or oligomeric polyisocyanates with biuret, allophanate and acyl urea structural elements, low-monomer or partially modified monomeric diisocyanates, triisocyanates and any mixtures whatsoever of the cited polyisocyanates. Mixtures with the cited structural units or mixtures of the modified polyisocyanates with the monomeric isocyanates can also be used, such mixtures being less preferable, however. Also very suitable are polyisocyanate prepolymers, which on average display more than one isocyanate group per molecule. They are obtained by pre-reacting a molar excess of for example one of the aforementioned polyisocyanates with an organic material displaying at least two active hydrogen atoms per molecule, e.g. in the form of hydroxyl groups.

Other suitable polyisocyanates include polymers or quasi-prepolymers, which are obtained by reacting an excess of a polyisocyanate with a polyhydroxyl-containing compound. The polyhydroxyl-containing compound can be the same as or a different polyol from the one that is reacted with a vinyl ether to form the protected polyol.

Preferred polyisocyanates are those containing a uretdione, isocyanurate, iminooxadiazine dione, acyl urea, biuret or allophanate structure, those polyisocyanates based on 1,6-hexamethylene diisocyanate, 3,5,5-trimethyl-1-isocyanato-3-isocyanatomethyl cyclohexane (IPDI), ω,ω′-diisocyanato-1,3-dimethyl cyclohexane (H₆XDI) and 4,4′-methylene bis(cyclohexyl isocyanate) (Desmodur® W, Bayer A G, Leverkusen) being preferred.

Also preferred are prepolymers in which the isocyanate Desmodur® W terminates the prepolymer, for example such prepolymers in which the hydroxyl component consists of an adduct of trimethylol propane (TMP) and ε-caprolactone, which has been urethanised with Desmodur W. Typically, unreacted Desmodur® W is then removed from the prepolymer by film distillation.

Low-monomer polyisocyanates based on Desmodur® W are particularly preferred.

The present invention also provides a process for producing paint films by reacting blocked alcohols with diisocyanates or polyisocyanates in the presence of a catalyst. In principle any Lewis or Brønsted acid that accelerates the reaction of the blocked alcohol with the diisocyanate or polyisocyanate is suitable as catalyst.

Suitable Lewis acids are generally metal ions having a high charge density relative to the ion radius. They include inter alia the metal ions of the first, second and third main group of the periodic table. Also suitable are the divalent or tetravalent ions of the fourth main group and bismuth compounds. In addition to the main group elements, the metal ions of subgroup elements can also be used. The ions of zinc, the third subgroup, the fourth subgroup and the ions of the sixth subgroup are preferred here. Metal compounds such as zirconium(IV)-2-ethyl hexanoate and zinc-2-ethyl hexanoate are particularly preferred.

In addition to Lewis acids, Brønsted acids can also be used as catalysts. Organic and inorganic acids displaying a compatibility with the reactive 1C PUR system are suitable in principle. Organic compounds of phosphoric acid and derivatives thereof and of sulfuric acid or sulfonic acids are preferably used in this process. Tridecyl phosphate is particularly preferred.

An advantage of the process according to the invention can be seen in the fact that particularly low-viscosity products are obtained by blocking the hydroxyl groups to acetal structures. The use of large amounts of additional solvents can be avoided in this way. The 1C PUR paint system according to the invention is therefore especially suitable for use in so-called high-solid formulations. The addition of blocked alcohols to paint formulations with the aim of achieving low viscosities in the formulation is known, however (see also DE-A 2 424 522 and EP-A 0 908 479).

Due to the good volatility of the blocking agent, virtually no blocking agent remains in the finished paint. Its properties are thus no longer determined by the blocking agent, as is the case with classical blocked isocyanate formulations.

One isocyanate group equivalent (1 val) is typically reacted with 0.7 to 1.3 val of the blocked alcohol. A ratio of 1 to 0.8 to 1.2 is preferred, particularly preferably 1:1.

In the process according to the invention 0.01 to 10 wt. %, preferably 0.1 to 2.5 mass %, of one of the catalysts described above is added. A quantity of 0.5 to 1.9 wt. % catalyst is particularly preferred.

In the context of the process according to the invention the reaction takes place in a temperature range of 70 to 150° C., a temperature range of 80 to 120° C. being preferred, with a temperature range of 90 to 100° C. being particularly preferred.

The reaction period is an important parameter of the process according to the invention. The reaction can be performed for a period of 10 minutes to 100 minutes. A period of 15 to 60 minutes is preferred, with a period of 20 to 40 minutes stoving time being particularly preferred.

The invention finally also provides the polyurethane paint films produced by the process according to the invention.

Suitable catalysts for crosslinking are for example zinc-2-ethyl hexanoate and zirconium-2-ethyl hexanoate. The preferred catalyst is zinc-2-ethyl hexanoate.

The preferred area of application of the processes according to the invention is their use for the production of top coats, in particular for the painting of plastics.

High-grade coatings that are free from releasing substances and paint coatings with low yellowing values are obtained with the polyols blocked according to the invention.

The invention is described by means of the following examples.

### EXAMPLES

Unless otherwise specified, quantities stated in percentages [%] are percentages by weight [wt. %].

### Production of the Starting Materials

Production of the blocked alcohols by reaction of e.g. butanediol with dihydropyran typically takes place in the presence of acid sites, e.g. in the presence of aluminium phosphate or aluminium sulfate in a non-protic solvent such as e.g. dichloromethane or chloroform at room temperature. Following the reaction the acid catalyst is filtered off and can be reused. Instructions for the production are provided for example by Nishiguchi, Takeshi; Kawamine, Katsumi; Ohtsuka, Tomoko in J. Chem. Soc., Perkin Trans. 1 1992, 1, 153-6. The blocking agent dihydropyran that is used was obtained from Aldrich and used without further purification.

### Polyol 1

72.1 g (0.8 mol) 1,4-butanediol and 20 g acid aluminium phosphate are suspended in 590 g chloroform. 161 g dihydropyran (1.92 mol) are added; the mixture is stirred overnight at 35° C. and the catalyst removed by filtration. Yield: 192 g (97% of theoretical).

### Polyol 2

(See table below with examples). This is a reaction product of Desmodur® N3600 (Bayer A G, HDI trimer) with an excess of butanediol. Excess butanediol is removed by film distillation. The product is blocked with dihydropyran in the same way as Polyol 1.

### Polyisocyanate 1

The polyisocyanate that is used is a polyisocyanate with an isocyanurate structure (Desmodur® W, NCO content 15.1%, solid, proportion of Desmodur® N3300 approx. 15%, Bayer A G, Leverkusen). Production is described below: 2620 g 4,4′-diisocyanatodicyclohexyl methane are trimerised at 60° C. with 6 g of a 10% catalyst solution of trimethyl benzyl ammonium hydroxide, dissolved in 2-ethylhexanol:methanol=5:1, at a temperature of 60-75° C. until an NCO content of 26.8% is obtained. 0.5 g bis(2-ethylhexyl) phosphate are added to terminate the trimerisation reaction. 130 g of an isocyanurate polyisocyanate based on diusocyanatohexane (HDI), obtained according to example 12 of EP-A 0 330 966, are then added to the clear crude solution and monomeric 4,4′-diisocyanatodicyclohexyl methane is separated off at 200° C./0.15 mbar by film distillation. A light, pale yellowish solid resin is obtained with an NCO content of 15.1%, a melting point of approx. 100° C., a content of monomeric diisocyanate of <0.2% and an average NCO functionality calculated from the NCO content of 3.5. This is dissolved in butyl acetate to make a 60 to 70% solution for production of the paints.

Manufacturing instructions for W prepolymers:

### Polyisocyanate 2

Production of a prepolymer based on an adduct of trimethylol propane with two equivalents of ε-caprolactone with Desmodur® W.

262 g (1 mol) Desmodur® W (molecular weight 262 g/mol) are reacted with 39.4 g (0.1 mol) of an adduct of trimethylol propane with two equivalents of ε-caprolactone (molecular weight 394.1 g/mol). The reaction is performed under nitrogen. The reaction mixture is heated slowly to 110° C. and kept at this temperature until the target NCO value of 23.7% is reached. The NCO value is reduced slightly. The excess isocyanate is separated off at 190° C. by film distillation. A product is obtained with an NCO value of 10.68%. The resin that is formed is dissolved in butyl acetate to make a 70% solution for further reactions.

### Polyisocyanate 3

Production of a prepolymer based on an adduct of trimethylol propane with three equivalents of ε-caprolactone with Desmodur® W.

524 g (2 mol) Desmodur® W (molecular weight 262 g/mol) are reacted with 105.3 g (0.2 mol) of an adduct of trimethylol propane with three equivalents of ε-caprolactone (molecular weight 526.2 g/mol). The reaction is performed under nitrogen. The reaction mixture is heated slowly to 110° C. and kept at this temperature until the target NCO value of 22.7% is reached. The NCO value is reduced slightly. The excess isocyanate is separated off at 190° C. by film distillation. A product is obtained with an NCO value of 9.6%. The resin that is formed is dissolved in butyl acetate to make a 60% solution for further reactions.

### Example For Paint Compositions

### Production of the Reactive 1C PUR Paint Mixture

### EXAMPLES

The polyisocyanates listed in the table below are processed stoichiometrically with polyols according to the formulations listed below to form clear lacquers with the addition of the commonly used additives Baysilone® OL 17 (Bayer A G, flow control agent, 0.1% solid on solid binder) and Modaflow® (0.01% solid on solid binder).

| Paint formulation A | Wt. % |
|---|---|
| Polyisocyanate 1 | 35.94 |
| Polyol 1 | 34.82 |
| Baysilone ® OL 17, 10% in xylene | 0.48 |
| Modaflow ® , 1% in xylene | 0.48 |
| Tinuvin ® 292, 10% in xylene | 4.78 |
| Tinuvin ® 1130, 10% in xylene | 9.56 |
| Zinc-2-ethyl hexanoate | 1.99 |
| BA/SN 100 (1:1) | 6.77 |
| Total | 100.00 |

Ratio of blocked NCO/OH: 1.0, solids content: approx. 50%, catalyst content: 1.99% (solid on solid binder)

The blocking agent blocked polyisocyanate that is used for the process according to the invention is compared with a polyisocyanate VP LS 2253 (Bayer A G), which is a polyisocyanate blocked with dimethyl pyrazole (hexamethylene diusocyanate trimer, dissolved in methoxypropyl acetate/solvent naphtha, blocked NCO content 10.75%).

| | Example | | | | |
|---|---|---|---|---|---|
| | 1 | 2 | 3 | 4 | Comparison |
| Description | Polyol 1 and Polyol 2 | | Polyol 1 | | Desmodur ® |
| | | | | | VP LS 2253 |
| Composition | 26.45% Polyol 1 | | 33.13% Polyol 1 | | |
| | 6.64% Polyol 2 | | 35.68% Desmodur ® | | |
| | 36.57% Desmodur W ® | | W trimer | | |
| | trimer | | 1.43% zinc-2-ethyl | | |
| | 1.40% zinc-2-ethyl | | hexanoate | | |
| | hexanoate | | 14.88% butyl | | |
| | 14.47% butyl acetate | | acetate | | |
| | 14.47% SN 100 | | 14.88% SN 100 | | |
| Form in which supplied | 70% in BA/SN 100 | | 70% in BA/SN 100 | | 75% in |
| | (1:1) | | (1:1) | | MPA/SN |
| | | | | | 100 (8:17) |
| PIC basis | Desmodur W trimer | | Desmodur W trimer | | N 3300 |
| Blocking agent | Blocked alcohol | | Blocked alcohol | | Dimethyl |
| | | | | | pyrazole |
| Polyol | — | | — | | A 870 |
| Catalyst | 1.9% zinc-2-ethyl | | 1.9% zinc-2-ethyl | | 1.0% DBTL |
| | hexanoate | | hexanoate | | |
| Injection solids content | 62.5 | | 69.8 | | 52.0 |
| [%] | | | | | |
| Flow time ISO-5 beaker | 26 | | 19 | | 26 |
| [s] | | | | | |
| Visual assessment of | Yellowish, clear | | Yellowish, clear | | Clear |
| paint | | | | | |
| Stoving conditions | 30′ 90° C. | 30′ 100° C. | 30′ 90° C. | 30′ 100° C. | 30′ 140° C. |
| Visual assessment of | OK | OK | OK | OK | OK |
| paint film | | | | | |
| Pendulum damping | 95 | 96 | 53 | 99 | 139 |
| (König) [vibrations] | 133 | 134 | 74 | 139 | 195 |
| [s] | | | | | |
| Solvent resistance | | | | | |
| (X/MPA/EA/Ac) [Score]¹⁾ | | | | | |
| 1 min | 0022 | 0022 | 3133 | 0011 | 2244 |
| 5 min | 4044 | 4044 | 4144 | 0034 | 3344 |
| Chemical resistance [° C.] | | | | | |
| (gradient oven) | | | | | |
| Tree sap | 52 | >68 | 60 | >68 | 36 |
| Brake fluid | 42 | 48 | 36 | 48 | 36 |
| Pancreatin, 50% | 36 | 40 | 36 | 36 | 36 |
| NaOH, 1% | 65 | >68 | 62 | >68 | 46 |
| H₂SO₄, 1% | 36 | 39 | 36 | 36 | 43 |
| FAM, 10 min [Score]¹⁾ | 0 | 0 | 0 | 0 | 1 |
| Heat yellowing | | | | | |
| Clear lacquer on solvent | | | | | |
| base coat | | | | | |
| Initial yellowing [b] | 2.4 | 3.6 | 3.3 | 3.2 | 4.5 |
| Overstoving yellowing 30′ | 0.1 | 1.3 | | | |
| 110° C. [Δb] | | | | | |
| Overstoving yellowing 30′ | | | 0.1 | 0.5 | |
| 120° C. [Δb] | | | | | |
| Overstoving yellowing 30′ | | | | | 0.8 |
| 160° C. [Δb] | | | | | |
| Clear lacquer on water base | | | | | |
| coat Initial yellowing [b] | 1.9 | 1.6 | 2.1 | 2.8 | 2.4 |
| | 0.3 | 0.8 | 0.1 | 0.2 | 0.2 |

¹⁾0 - good; 5 - poor

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A coating system comprising organic polyisocyanates with at least two isocyanate groups, at least difunctional alcohols that are not present in their O—H acid form, and a catalyst to accelerate the alcohol-isocyanate reaction.

2. The coating system according to claim 1, wherein unsaturated enol ethers are used as a blocking agent for the alcohol component.

3. The coating system according to claim 1, wherein dihydropyran or dihydrofuran are used as a blocking agent for the alcohol component.

4. The coating system according to claim 1, wherein Lewis acids are used as the catalyst.

5. The coating system according to claim 4, wherein zinc-2-ethyl hexanoate or zirconium-2-ethyl hexanoate are used as the catalyst.

6. A process for producing polyurethane paint films comprising reacting blocked alcohols with polyisocyanates in the presence of one or more catalysts.

7. The process according to claim 6, wherein unsaturated enol ethers are used as blocking agent for the blocked alcohol component.

8. The process according to claim 6, wherein the blocking agent is selected from dihydropyran and dihydrofuran.

9. A surface coating obtained from the coating system according to claim 1.

10. A substrate coated with the surface coating according to claim 9.

11. The coating system according to claim 2, wherein Lewis acids are used as the catalyst.

12. The coating system according to claim 3, wherein Lewis acids are used as the catalyst.

13. The coating system according to claim 11, wherein zinc-2-ethyl hexanoate or zirconium-2-ethyl hexanoate are used as the catalyst.

14. The coating system according to claim 12, wherein zinc-2-ethyl hexanoate or zirconium-2-ethyl hexanoate are used as the catalyst.

15. The process according to claim 7, wherein the blocking agent is selected from dihydropyran and dihydrofuran.

16. A surface coating obtained from the coating system according to claim 2.

17. A substrate coated with the surface coating according to claim 16.

18. A surface coating obtained from the coating system according to claim 3.

19. A substrate coated with the surface coating according to claim 18.

20. A surface coating obtained from the coating system according to claim 4.

21. A substrate coated with the surface coating according to claim 18.

22. A surface coating obtained from the coating system according to claim 5.

23. A substrate coated with the surface coating according to claim 22.
